(19) United States
(12) Patent Application Publication
(10) Pub. No.: US 2009/0132215 A1
(43) Pub. Date: May 21, 2009

(54) ANALYTICAL MODEL GENERATION APPARATUS AND ANALYTICAL MODEL GENERATING METHOD

(75) Inventors: Misao Inoke, Kawasaki (JP); Rikako Shinomiya, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/271,899

(22) Filed: Nov. 16, 2008

(30) Foreign Application Priority Data
Nov. 16, 2007 (JP) 2007-297755

(51) Int. Cl. G06F 17/10; G06F 17/50

(52) U.S. Cl. 703/2

(57) ABSTRACT

A screw fastened position can be correctly defined in n analytical model generating method. It is determined whether or not a screw fastened portion exists in 3-dimensional design data. When the screw fastened portion exists, a hole of a member matching in the shape of a fixture (screw, bolt, rivet, etc.), the screw fastened position, and the screw shape is extracted. Then, a surface including the hole of the member is extracted, and the screw top shape is projected on the surface to generate attached surface data. The distance between the surfaces of the two members is calculated. When the distance is equal to or less than a predetermined value, attached surface data is defined as a screw fastened position on the two surfaces.

### BACKGROUND OF THE INVENTION

1. Field of the Invention

The present invention relates to an analytical model generation apparatus and its generating method.

2. Description of the Related Art

An analytical model including a screw fastened portion of a device to be evaluated is generated using a CAD device to evaluating the connection intensity of the screw fastened portion in a thermal cycle test and a fall test of information equipment such as a notebook PC etc. Then, the analytical model is divided into a plurality of mesh areas, and a structural analysis is performed to estimate the force to the screw fastened portion when an impact is applied, a shift of a position of a member by the impact, the force applied to the screw fastened portion in a thermal cycle test, etc.

In the patent document 1, an analytical model generation apparatus for generating an analytical model from a CAD model retrieves a fastened portion of the CAD model, and highlights the fastened portion.

In the patent document 2, a mesh data generation apparatus includes: an edge extraction unit for extracting an edge corresponding to a joint portion of two parts on the basis of 3-dimensional design data; a generation unit for generating mesh data for each of a plurality of parts forming a structure on the basis of the 3-dimensional design data; a node extraction unit for extracting a node corresponding to the edge from the mesh data; and a node connection unit for connecting a node of one edge to a node of another edge.

In the patent document 3, screen display data and part name list data are automatically generated from assembly design data by operation block and stored, the screen display data and the part name list data are read, and the part assembly order is displayed.

In the patent document 4, a 3-dimensional shape recognition apparatus includes: a closed plane extraction device for extracting a closed plane of a front view and a back view of an object; a closed plane position and shape determination device for comparing the position of each closed plane and determining an arrangement and a shape on each figure; and a 3-dimensional shape determination device for determining a 3-dimensional shape displayed by a closed plane on the basis of a determination result by the plane position and shape determination device.

The patent document 5 discloses reading a 3-dimensional sheet metal model in a plane unit, classifying models into a plate thickness group, a group of planes to be developed, and a formed plane group, joining planes by plane type, grouping planes by each formed shape, and adding basic attribute data of material quality, plate thickness, and developed drawings.

FIGS. 1A through 1D and 2A through 2C show conventional analytical models not including screws and conventional analytical models including screws.

FIG. 1A shows an analytical model including a screw 21. FIG. 1B shows the shape of the screw. The diagonally shaded area shown in FIG. 1C indicates a reverse contact surface of a cover member 23. The diagonally shaded area shown in FIG. 1D shows the top surface of a base member, and the central circle as a screw fastened cylindrical surface into which a screw is inserted.

FIG. 2A shows an analytical model not including a screw. The diagonally shaded area shown in FIG. 2B shows a reverse contact surface of the cover member 23 generated in the conventional analytical model generating method. FIG. 2C shows the top surface of a base member 25.

In the conventional analytical model generating method, a connected portion is defined as described below.

(1) A user specifies two contact surfaces of the members as a screw fastened portion (the reverse of the cover member 23 shown in FIGS. 1 and 2, and the contact surface of the top surface of the base member), and contact surfaces to be set as a group.

(2) When analytical models are divided into mesh areas, each member shares mesh areas of planes within a specific distance as connected positions.

In the method (1) above, a user has to specify the contact surfaces of the members and planes to be set as a group, it takes a longer operation time of the user when the number of screw fastened positions increases.

In addition, in the methods (1) and (2) above, for example, the entire contact surface (diagonally shaded area of the cover member shown in FIG. 1C) between the cover member and the base member is divided into mesh areas, the attached area is lager than the actual fixed area by a screw, and the rigidity of the connected portion is higher than an actual value.

Furthermore, in the method (2) above, since the attached portion of a member not fastened by a screw is automatically shared in mesh areas, the user has to correct the portion not to be included in a mesh form.
[Patent Document 1] Japanese Patent No. 3800916
[Patent Document 2] Japanese Laid-open Patent Publication No. 2006-178594
[Patent Document 3] Japanese Laid-open Patent Publication No. 2006-318166
[Patent Document 4] Japanese Laid-open Patent Publication No. 2000-259697
[Patent Document 5] Japanese Laid-open Patent Publication No. 2001-142517

### SUMMARY OF THE INVENTION

The present invention aims at providing an analytical model generation apparatus and its method for correctly defining a portion to be fastened by a fixture.

The analytical model generation apparatus includes: an extraction unit for extracting plural pieces of data of a member in design data, having a hole into which a fixture is inserted and fixed by the fixture; a distance acquisition unit for acquiring a distance between the plural pieces of data of the member; and a generation unit for generating contact data depending on the fixture on a contact surface between the plural pieces of data of the member when the distance is below a certain value.

The analytical model generation apparatus can generate an analytical model for which a portion to be fastened by a fixture is correctly defined by generating contact data depending on the fixture on the contact surface of a member. The accuracy of analysis can be improved by performing a structural analysis on the basis of the analytical model.

In the above-mentioned analytical model generation apparatus, the generation unit obtains the contact data size from the hole size. For example, since the hole size is associated with the axis diameter of a fixture, the fixture is designated when the hole size is designated, thereby determining the fixture head size. Thus, the fixture head size can determine the contact data size.

With the above-mentioned configuration, the contact data size can be determined by the hole size.

In the above-mentioned analytical model generation apparatus, the generation unit obtains the contact data size on the basis of the fixture data in the design data or the data of the member related to the fixing by a fixture. For example, a member related to the fixing by a fixture refers to a member such as a washer etc. to be inserted between a fixture and a member to be fixed.

With the above-mentioned configuration, the contact data size can be determined on the basis of the size of a fixture or the size of a member related to the fixing by a fixture.

In the above-mentioned analytical model generation apparatus, the generation unit further includes an analysis unit for inserting contact data into the design data and performing an analysis on the basis of the design data.

With the above-mentioned configuration, an analysis can be performed on the basis of the design data including the contact data. The analysis unit performs, for example, a structural analysis by dividing an analytical model into mesh areas.

Thus, since the rigidity of a fixed portion by a fixture can be more correctly obtained, the accuracy of analysis of the structural analysis can be improved.

### BRIEF DESCRIPTION OF THE DRAWINGS

FIGS. 1A through 1D show a conventional analytical model including a screw;

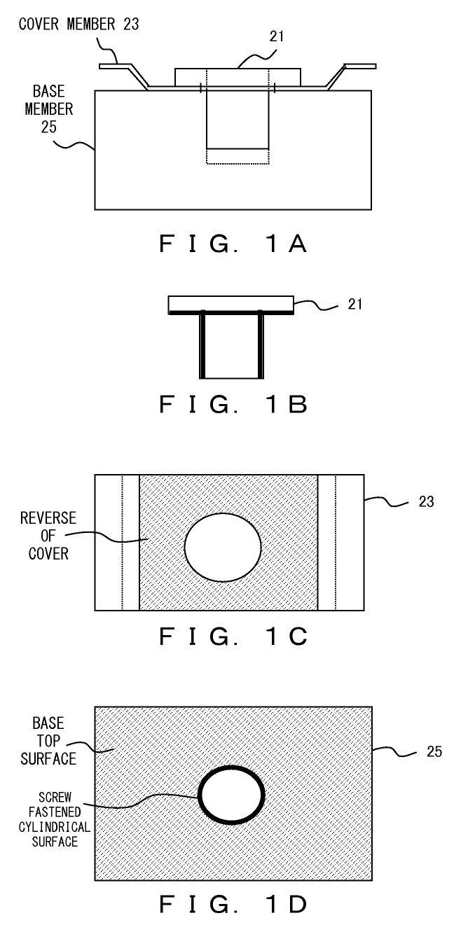

FIGS. 2A through 2C show a conventional analytical model not including a screw;

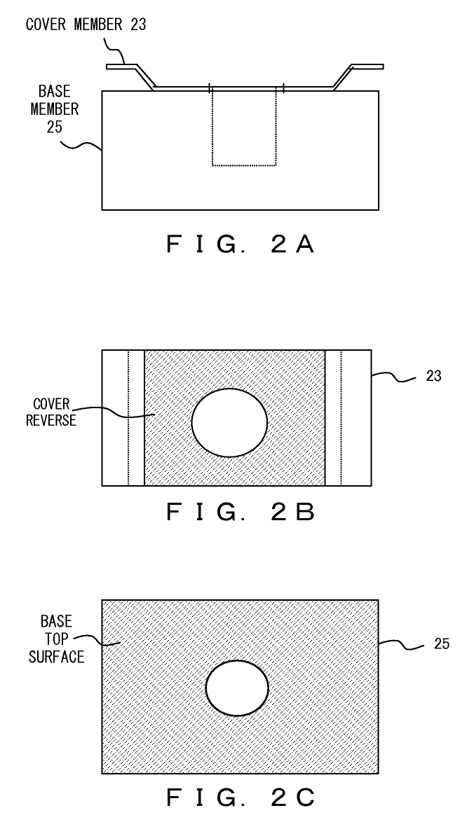

FIG. 3 is a flowchart of the analytical model generating process according to an embodiment of the present invention;

FIG. 4 is a flowchart of the details of the analytical model generating process;

FIGS. 5A and 5B show a 3-dimensional model of a screw and its data configuration;

FIGS. 6A and 6B show the 3-dimensional model of a cover member and its data configuration;

FIGS. 7A and 7B show the 3-dimensional model of a base member and its data configuration;

FIGS. 8A through 8C show an analytical model according to an embodiment of the present invention;

FIGS. 9A and 9B show the attached surface data of a cover member and its data configuration;

FIGS. 10A and 10B show the attached surface data of a base member and its data configuration; and

FIG. 11 is a flowchart of the confirming process of a contact surface.

### DETAILED DESCRIPTION OF THE PREFERRED EMBODIMENTS

Described below are the preferred embodiments of the present invention. The analytical model generating method according to an embodiment of the present invention is, for example, to generating an analytical model for use in a structural analysis of a notebook computer.

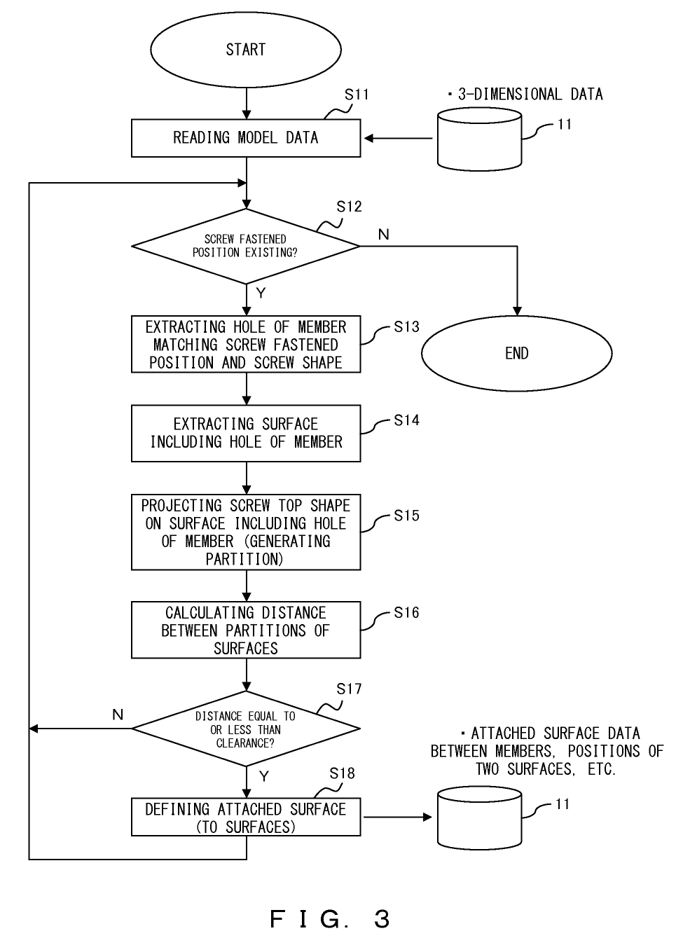

FIG. 3 is a flowchart of the analytical model generating process according to an embodiment of the present invention. The analytical model generating method according to the embodiment is read as, for example, a program of a CAD device. The CAD device includes a storage device for storing 3-dimensional design data etc., a control unit having an MPU etc. for executing a program, memory for storing data, a display device for displaying a 3-dimensional model, an input device etc. used by a user in performing an inputting operation. The following processes are performed by the control unit of the CAD device.

3-dimensional design data indicating an assembly status of a member (including member data and hereinafter referred to as 3-dimensional data) is read from a database 11 stored in the storage device of the CAD device (FIG. 3, S11). The process corresponds to the extraction unit for extracting member data.

Next, it is determined whether or not there is a screw fastened portion in the 3-dimensional data (S12). The determination as to whether or not there is a screw fastened portion is performed by determining, for example, whether or not the coordinate data indicating a screw fastened position is close to the coordinates data of the center of the hole in the member.

If there is no screw fastened portion (NO in S12), then the process terminates. On the other hand, when there is a screw fastened portion, control is passed to S 13, the form of the screw (corresponding to a fixture) and the hole of a member which is located at the screw fastened position are extracted from the 3-dimensional data. The fixture includes can be a screw, a bolt, a rivet, etc.

In the process above, for example, the data indicating the screw fastened position is compared with the data indicating the center of the hole in the member, and a hole into which the screw is inserted is designated depending on whether or not the comparison result indicates the same coordinates or the close positions on the same axis.

Next, a surface including the hole in the member is extracted (S14). In this process, a surface of a member including the corresponding hole is extracted with reference to the 3-dimensional data.

Next, the screw top shape is projected on the surface including the hole in the member (S15). A result obtained by projecting the screw top shape on the surface is referred to as a partition. A screw top shape refers to the shape of the bottom surface of a screw head portion. The bottom surface of the screw can be the same shape as the screw head portion, smaller than the head, or larger than the head. The shape of the bottom surface is not limited to a circle, but can be any shape. The top shape is not limited to the shape of the bottom surface of the fixture itself, but can be any shape of other members such as a washer etc. inserted between the fixture and the member. That is, the shape of a fixture such as a screw or the bottom surface of a member related to a fixture can be projected to the contact surface of the member to be fixed.

In the process above, for example, when the screw top shape is a circle, concentric areas having the diameter of the screw top as an outside diameter and the hole diameter as an inside diameter are generated as partitions.

Next, the inter-partition distance on the surface of each member is calculated (S16). Next, it is determined whether or not the calculated inter-partition distance is equal to or less than a predetermined clearance (S17). In this process, it is determined whether or not two members contact each other by determining whether the distance between the members fixed by a screw is equal to or less than a predetermined value (for example, 0.1 through 0.2 mm. The process above corresponds to the distance acquisition unit.

When the inter-partition distance is equal to or less than a predetermined value (YES in S17), control is passed to S18, and the contact surface of two members fixed by a screw is defined. In this process, a partition generated by projecting the screw top shape is defined as the attached surface of the corresponding surface of the member, and the attached surface data (corresponding to the contact data) indicating the attached surface is stored in the database 11. The process above corresponds to the generation unit for generating contact data.

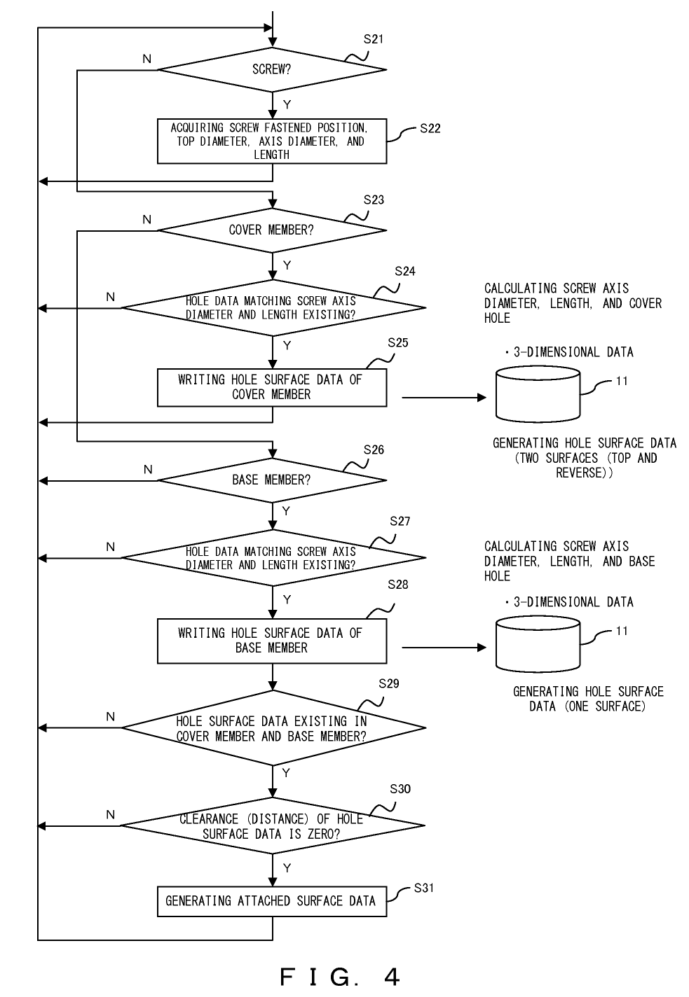

FIG. 4 is a detailed flowchart of the analytical model generating process shown in FIG. 3. First, it is determined whether or not the read 3-dimensional data is the data of a screw (S21 shown in FIG. 4). If it is determined that it is screw data (YES in S21), control is passed to S22, and the coordinates of the screw fastened position (for example, the position data indicating the center of the screw head portion), the diameter of the screw top (diameter of the bottom surface), the axis diameter, and the length are acquired.

If it is determined that the member is not a screw (NO in S21), control is passed to step S23, and it is determined whether or not it is a cover member.

If it is a cover member (YES in S23), control is passed to step S24, and it is determined whether or not there is hole data matching the axis diameter and the length of the screw in the cover member.

In the process above, for example, a comparison is made between the position data of a screw and the position data of the hole in the member, the axis diameter data and the hole diameter data, and the axis length data and the hole depth data to determine whether or not they indicate the same positions, whether or not the relationship between the axis diameter and the hole diameter satisfies a predetermined condition, whether or not the hole depth (including a through hole) is longer than the length of the axis of the screw.

When there is a corresponding hole data (YES in S24), control is passed to S25, and the hole surface data on the surface and the reverse of the cover member are generated and written to the database 11. If it is determined in step S23 that it is not a cover member (NO in S23), then control is passed to S26, and it is determined whether or not the member configuring the screw fastened portion is a base member.

If it is determined that it is a base member (YES in S26), control is passed to S27, and it is determined whether or not there is a hole matching a screw fastened position, a screw axis diameter, and the length of a screw in the base member.

If there is a matching hole (YES in S27), then control is passed to S28, the hole surface data of the base member is generated, and written to the database 11. The hole surface data refers to the data indicating the surface including the hole of the member.

Next, it is determined whether or not hole surface data has been generated in the cover member and the base member (S29).

If hole surface data is generated (YES in S29), control is passed to step S30, and it is determined whether or not the distance between the two pieces of hole surface data is zero. In this process, it is determined whether or not two surfaces depending on the two pieces of hole surface data contact each other. If it is determined that the distance between the hole surface data is zero (YES in S30), then it is determined that the surfaces are contact surfaces fixed by a screw, control is passed to step S31, attached surface data indicating the area enclosed by concentric circles having the diameter of the screw top (diameter of the bottom surface of the screw) as an outside diameter and the hole diameter as an inside diameter is generated, and stored in the database 11.

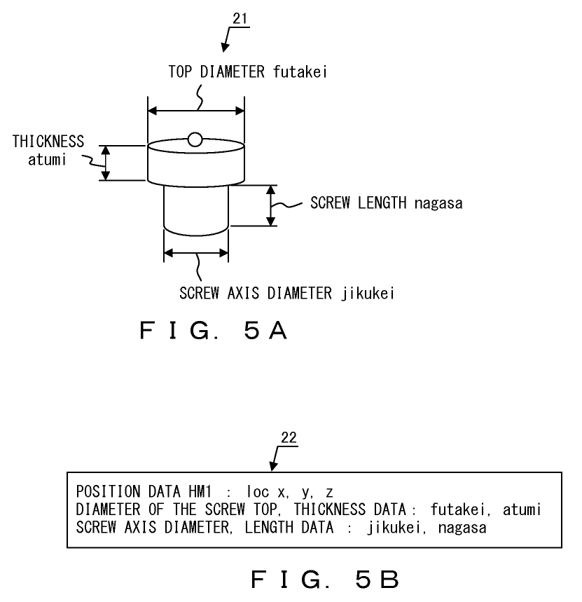

The 3-dimensional analytical model generated in the analytical model generating method according to an embodiment of the present invention and its data configuration are described below with reference to FIGS. 5 through 10.

FIGS. 5A and 5B show a 3-dimensional model of the screw 21 and an example of the data configuration.

As shown in FIGS. 5A and 5B, a 3-dimensional model of the screw 21 is defined with the position of the center of the head portion of the screw 21 as position data when the member is fixed by the screw 21, and the thickness of the head portion, the top diameter of the head portion, the screw length, the screw axis diameter are defined as member data 22 of the 3-dimensional model.

As shown in FIG. 5B, the member data 22 of the screw 21 is configured by the position data HM1 ┌loc x, y, z┘ indicating the position at the 3-dimensional coordinates of the center point when the screw 21 is attached to the member, the top diameter data ┌futakei┘, the thickness data ┌atumi┘, the screw axis diameter data ┌jikukei┘, and the length data ┌nagasa┘ of the screw 21.

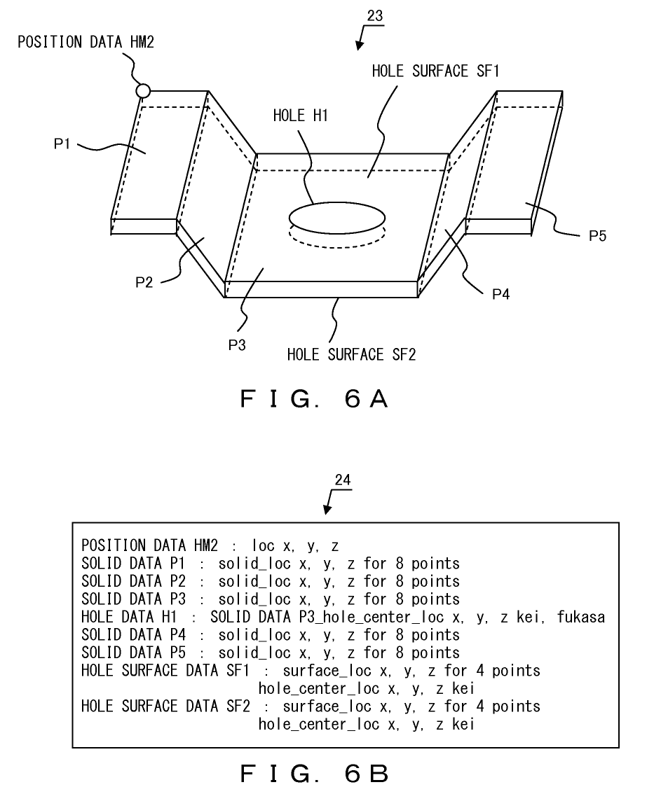

FIGS. 6A and 6B show a 3-dimensional model of the cover member 23 and an example of the data configuration.

As shown in FIG. 6A, the cover member 23 is configured by a left top surface position P1, a left side portion P2, an attachment portion P3 having a hole H1, a right side portion P4, and a right top surface portion P5.

As shown in FIG. 6B, 3-dimensional member data 24 of the cover member 23 is configured by position data HM2 as a reference point of a member, solid data P1 through P5 formed by the position data of each portion of the member, the hole data H1, and the hole surface data SF1 and SF2.

The position data of the point at the upper left corner of the member is defined as the position data HM2 ┌loc x,y,z┘ on the basis of the origin of the 3-dimensional coordinates with the cover member 23 assembled with other members.

A total of eight pieces of position data at the four corners of each of the surface and the reverse of the left top surface portion P1 are defined as the solid data P1 ┌solid_loc x,y,z┘ (eight pieces of data) of the left top surface portion P1. Similarly for the left side portion P2, a total of eight pieces of position data at the four corners of each of the surface and the reverse of the left side portion P2 are defined as the solid data P2 ┌solid_loc x,y,z┘ of the left side portion P2.

A total of eight pieces of position data at the four corners of each of the surface and the reverse of he attachment portion P3 in which a hole is made are defined as the solid data P3 ┌solid_loc x,y,z┘ of the attachment portion P3, and a total of eight pieces of position data at the four corners of each of the surface and the reverse of the right side portion P4 are defined as the solid data P4 ┌solid_loc x,y,z┘ of the right side portion P4. In addition, a total of eight pieces of position data at the four corners of each of the surface and the reverse of the right top surface portion P5 are defined as the solid data P5 ┌solid_loc x,y,z┘ of the right top surface portion P5. Furthermore, the position data of the center of the hole H1, the hole diameter, and the hole depth are defined as the hole data H1 ┌solid_loc x,y,z, kei, fukasa┘.

Furthermore, the hole surface data SF1 and SF2 are defined as the surface data of the surface and the reverse having a hole. Four pieces of position data surface_loc x,y,z at the four corners of the surface, the position data hole_center_loc x,y,z of the center of the hole, and the hole diameter kei are defined as the hole surface data SF1 ┌surface_loc x,y,z, hole_center_loc x,y,z, kei┘. Similarly, four pieces of position data surface_x,y,z at the four corners of the reverse, the position data hole_center_loc x,y,z at the center of the hole, and the hole diameter kei are defined as the hole surface data SF2 ┌surface_loc x,y,z, hole_center_loc x,y,z, kei┘.

For the hole surface data SF2 on the reverse, the attached surface data (described later) indicating the portion to be fixed by the screw 21 is defined, and a structural analysis is performed using the attached surface data.

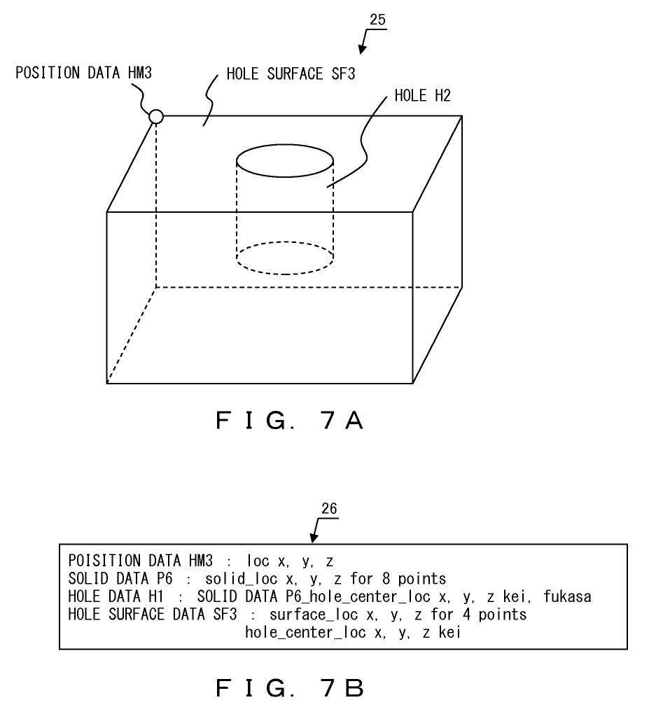

FIGS. 7A and 7B show a 3-dimensional model of a base member and an example of the data configuration.

As shown in FIG. 7A, the base member 25 is rectangular, and has a screw hole H2 at the center portion.

As shown in FIG. 7B, member data 26 of the 3-dimensional model of the base member 25 includes position data HM3 indicating the reference position of a member, solid data P6 including the position data at the eight vertexes of the member, the hole data H2, and hole surface data SF3.

With the base member 25 assembled with other members, the position data at the upper left corner point of the base member 25 is defined as the reference position data position data HM3 ┌loc x,y,z┘ using the origin of the 3-dimensional coordinates as a reference.

A total of eight pieces of position data including the four pieces of position data at the four corners of the top surface of the base member 25 and four pieces of position data on the bottom surface of the base member 25 are defined as solid data P6 ┌solid_loc x,y,z┘.

In addition, the coordinates at the center of the hole H2, the hole diameter kei, and the hole depth fukawa are defined as the hole data H2 ┌solid data P6_hole_center_loc x,y,z kei fukasa┘.

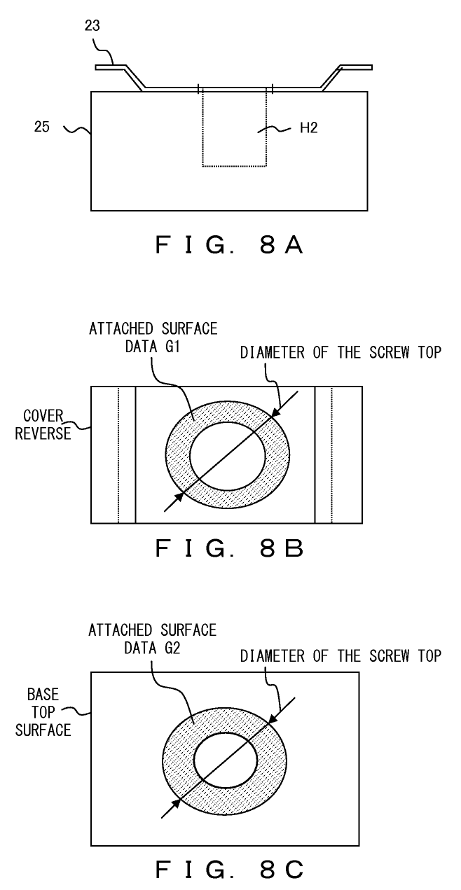

FIGS. 8A and 8B show an analytical model generated in the analytical model generating method according to an embodiment of the present invention.

As shown in FIG. 8A, the process of fixing the cover member 23 (refer to FIG. 6) to the base member (refer to FIG. 7) by the screw 21 is described below with reference to the flowchart shown in FIG. 4.

In the process in step S22 shown in FIG. 4, for example, each piece of data of the screw fastened position (reference position data HM1 of the screw), the top diameter, the axis diameter, and the length is acquired from the member data 22 of the screw 21 shown in FIG. 5.

Next, in the process in steps S23 and S24, the member data 24 of the cover member 23 shown in FIG. 6 is acquired, and it is determined whether or not the position of the screw 21 matches the position of the hole, and there is a hole matching in the screw axis diameter and length of the screw 21.

When there is a hole satisfying the conditions, the hole surface data SF1 and SF2 for specification of the upper surface and the lower surface including the hole are added to the member data 24 of the cover member 23 (S25, FIG. 4). In this process, the surface data including the hole into which the screw 21 is inserted is added to the member data 24 of the cover member 23.

Next, in the process in step S27 shown in FIG. 4, the member data 26 of the base member 25 shown in FIG. 7 is acquired, and it is determined whether or not the position data of the screw 21 matches the center of the hole, and there is a hole matching the screw diameter and the length.

When there is a hole satisfying the conditions, the hole surface data SF3 for satisfying the top surface including the hole is added to the member data 26 of the base member 25 in the process in S28 shown in FIG. 4.

Next, it is determined whether or not there is hole surface data in the cover member 23 and the base member 25 (S29 shown in FIG. 4). If there is hole surface data it is determined whether or not the distance between the hole surface data of two members is zero (S30 shown in FIG. 4). That is, it is determined whether or not the hole surface data SF1 and SF2 of the cover member 23 shown in FIG. 6 contact the surface specified by the hole surface data SF3 of the base member 25.

When the distance between the hole surface data of the two members is zero, the two members are fixed by a screw, and the surfaces of the two members contact each other. Therefore, concentric areas having the hole diameter of each member as an inside diameter and the diameter of the screw top as an outside diameter are generated as attached surface data on the hole surface data (S31 shown in FIG. 4).

FIG. 8B shows attached surface data G1 of the reverse of the cover member 23 generated in the process above and attached surface data G2 of the top surface of the base member 25.

The attached surface data G1 is formed by concentric areas including the diameter of the hole of the cover member 23 as an inside diameter and the top diameter (cap diameter) of the screw 21 as an outside diameter as a part of the surface data of the reverse of the cover member 23 (surface in contact with the base member 25).

Similarly, the attached surface data G2 is formed by concentric areas including the diameter of the screw hole of the base member 25 as an inside diameter and the top diameter of the screw 21 as an outside diameter as a part of the surface data of the top surface of the base member 25 (surface in contact with the cover member 23).

The attached surface data G1 of the cover member 23 and the attached surface data G2 of the base member 25 are used as the data indicating the fastened portion by the screw 21 of an analytical model. By performing a structural analysis using the attached surface data G1 and G2, the force applied to the fastened portion of the screw 21 by a fall test etc. can be more correctly calculated.

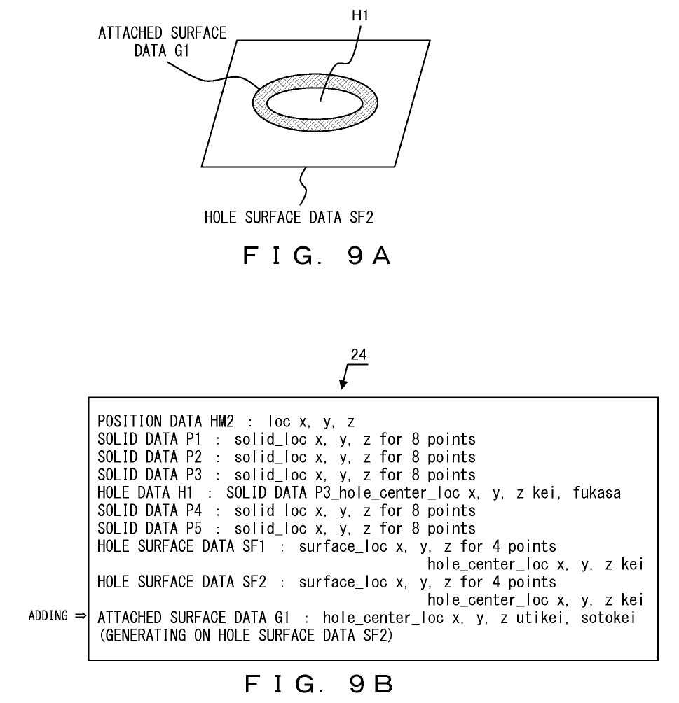

FIGS. 9A and 9B show the attached surface data of a cover member generated in the analytical model generating method according to an embodiment of the present invention and its data configuration.

As shown in FIG. 9A, the attached surface data G1 for specification of the area enclosed by a concentric circle having the hole diameter as an inside diameter and the top diameter of the screw 21 as an outside diameter is generated on the hole surface data SF2 of the reverse of the cover member 23 (surface in contact with the base member 25).

FIG. 9B shows data configuration of the member data 24 of the cover member 23. A point different from FIG. 6B is the added attached surface data G1. The attached surface data G1 is configured by the center coordinates hole_center_loc x,y,z of the hole H1, the inside diameter utikei (hole diameter), and the outside diameter sotokei (top diameter of the screw 21).

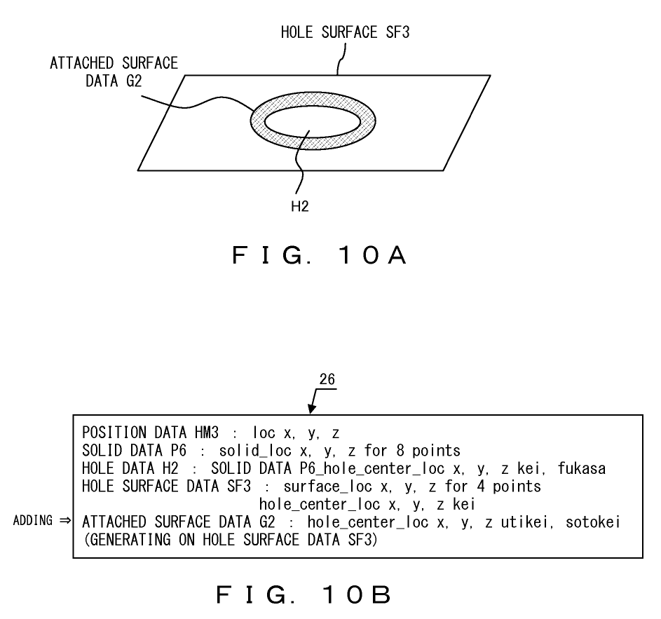

FIGS. 10A and 10B show the attached surface data of a base member 25 generated in the analytical model generating method according to an embodiment of the present invention and its data configuration.

As shown in FIG. 10A, the attached surface data G2 for specification of the area enclosed by concentric circles having the hole diameter as an inside diameter and the top diameter of the screw 21 as an outside diameter is generated on the hole surface data SF2 on the surface side of the base member 25 (surface in contact with the cover member 23).

FIG. 10B shows the data configuration of the member data 26 of the base member 25. A point different from FIG. 5 is the added attached surface data G2. The attached surface data G2 is configured by the center coordinates hole_center_loc x,y,z of the hole H2, the inside diameter utikei (hole diameter), and the outside diameter sotokei (top diameter of the screw 21).

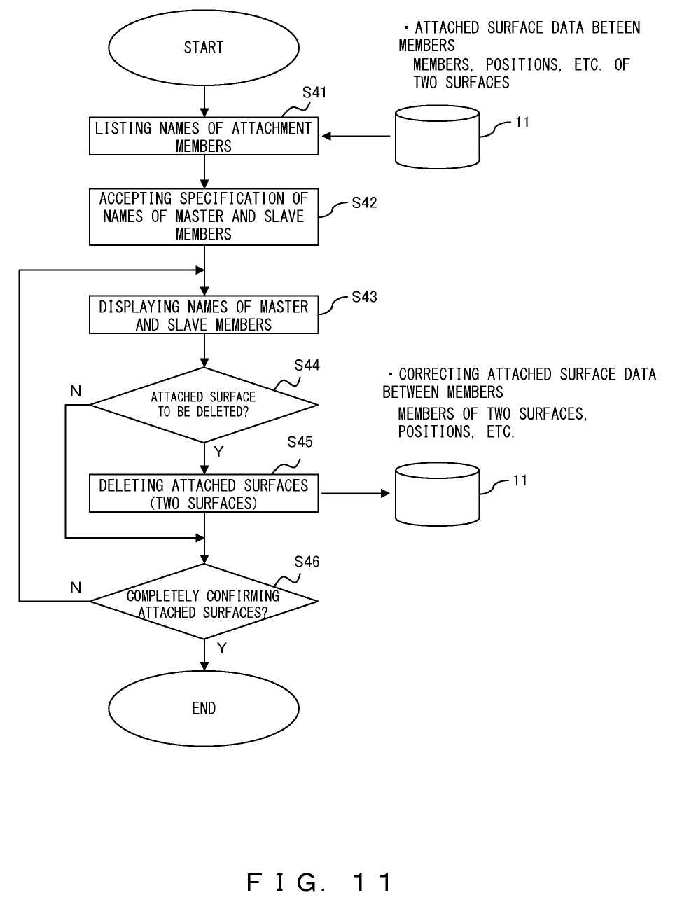

FIG. 11 is a flowchart of the process of a user confirming the attached surface after generating the attached surface data indicating the screw fastened position.

First, the control unit of the CAD device displays a list of the names of attached members for which an attached surface is defined (S41, FIG. 11). In this process, the member data for which the attached surface data is set is extracted, and the name of each member is displayed.

Next, the specification of master and slave member names by a user is accepted (S42). A master member refers to a member to which other members are attached, and a slave member refers to a member to be attached to the master member.

Next, the control unit displays the names of master and slave members (S43). In this process, a 3-dimensional model is displayed on the basis of the screw 21 and the member data so that the user can determine whether or not the member is fixed by the screw 21.

Then, it is determined whether or not the user has specified the deletion of the attached surface data of the corresponding member (S44). If the user has specified the deletion of the attached surface data, the attached surface data of the corresponding member is deleted from the database 11 (S45).

Although the center coordinates of the screw 21 match the center coordinates of the hole of the member, the hole diameter, etc., there can be a member not actually fixed by the screw 21. Therefore, the user is to visually confirm the member not fixed by the screw 21, and delete the corresponding attached surface data.

As described above, since the CAD device automatically generates the attached surface data indicating the screw fastened position and the attached surface data is displayed in the 3-dimensional model of a member. Therefore, the user can easily confirm on the displayed 3-dimensional image as to whether or not the generated attached surface data corresponds to a screw fastened position. Then, when the data does not correspond to a screw fastened position, the attached surface data is deleted. Thus, by displaying the attached surface data on the 3-dimensional model and the user confirming the displayed data, the time required to confirm and delete the attached surface data automatically generated by the CAD device can be considerably shortened.

Next, it is determined whether or not the user has completed confirming the attached surface (S46). If the attached surface has not been completely confirmed (NO in S46), control is returned to S43, and the next master and slave members are displayed. If all attached surfaces have been completely confirmed (YES in S46), the process terminates.

According to the embodiment above, attached surface data indicating the concentric areas having the hole diameter as an inside diameter and the top diameter of the screw 21 (diameter of the bottom surface of the screw 21) as an outside diameter can be automatically generated on the contact surfaces of at least two members fixed by the screw 21. Thus, an analytical model for which the fastened portion of the member by the screw 21 etc. is correctly defined can be generated.

By generating the above-mentioned analytical model, the force applied to the screw fastened position of a member in a fall test etc., a shift in position of the screw fastened position when the member falls, a shift in position of the member by thermal stress in a thermal cycle test can be correctly predicted, thereby obtaining an analysis result on a model close to an actual product. Thus, the accuracy of analysis by an analysis unit (built in an analytical model generation apparatus or another device) for performing a structure analysis can be enhanced.

According to the analytical model generation apparatus, an analytical model for which a fastened portion by a fixture is correctly defined can be generated. By performing the structural analysis using the analytical model, the accuracy of analysis can be enhanced.

In the above-mentioned embodiment, the area of the bottom surface where the head portion of the screw 21 contacts a member is equal to the area of the head portion of the screw 21, and the diameter of the bottom surface of the screw is equal to the diameter of the head portion. However, the present invention can also be applied to the case where the area of the bottom surface of the screw 21 is smaller than the area of the head portion of the screw 21, or the area of the bottom surface is larger than the area of the head portion of the screw 21.

The configuration of the present invention is not limited to the configuration according to the embodiment above. For example, the following configurations are acceptable.

(1) The member data including the contact surface data etc. for defining the screw fastened position of a 3-dimensional model is not limited to the data configuration according to the embodiment above, but can be other appropriate data configurations.

(2) In the embodiment above, attached surface data (contact data) is generated on the hole surface data indicating the reverse or top surface of a member, but only the attached surface data can be defined on the corresponding surface without generating hole surface data. In this case, it can be described whether or not the distance between attached surface data is zero as to determine whether or not the surfaces of two members contact each other.

What is claimed is:

1. An analytical model generation apparatus, comprising:
an extraction unit extracting plural pieces of data of a member in design data, having a hole into which a fixture is inserted and fixed by the fixture;
a distance acquisition unit acquiring a distance between the plural pieces of data of the member; and
a generation unit generating contact data depending on the fixture on a contact surface between the plural pieces of data of the member when the distance is below a certain value.

2. The apparatus according to claim 1, wherein
the generation unit obtains a size of the contact data from a size of the hole.

3. The apparatus according to claim 1, wherein
the generation unit obtains the contact data size on a basis of the fixture data in the design data or the data of the member related to fixing by the fixture.

4. The apparatus according to claim 1, wherein
the generation unit further comprises an analysis unit inserting contact data into the design data and performing an analysis on the basis of the design data.

5. The apparatus according to claim 1, wherein:
the generation unit has a same external shape between a head portion of the fixture and a shape of a bottom surface in contact with the member; and
data formed by an area excluding the hole is generated as the contact data.

6. The apparatus according to claim 1, wherein
the generation unit generates surface data indicating respective contact surfaces of the two members, and generates the contact data on the two pieces of surface data.

7. The apparatus according to claim 1, wherein
the fixture and the member are designed and manufactured by the analytical model generation apparatus.

8. An analytical model generating method, comprising:
an extraction step of extracting plural pieces of data of a member in design data, having a hole into which a fixture is inserted and fixed by a fixture;
a distance acquiring step of acquiring a distance between the plural pieces of data of the member; and
a generating step of generating contact data depending on the fixture on a contact surface between the plural pieces of data of the member.

9. The method according to claim 8, wherein
the generating step obtains a size of the contact data from a size of the hole.

10. The method according to claim 8, wherein
the generating step obtains a size of the contact data on a basis of data of the fixture in the design data or data of the member related to fixing by the fixture.

11. The method according to claim 8, further comprising
an analyzing step of performing an analysis on a basis of the design data by inserting contact data into the design data.
